(19) United States
(12) Patent Application Publication
(10) Pub. No.: US 2014/0106793 A1
(43) Pub. Date: Apr. 17, 2014

(54) METHOD AND APPARATUS FOR EFFICIENTLY PERFORMING PAGING IN A WIRELESS ACCESS SYSTEM THAT SUPPORTS A MULTI-RADIO ACCESS TECHNOLOGY

(71) Applicants: Eunjong Lee, Anyang-si (KR); Youngsoo Yuk, Anyang-si (KR); Heejeong Cho, Anyang-si (KR)

(72) Inventors: Eunjong Lee, Anyang-si (KR); Youngsoo Yuk, Anyang-si (KR); Heejeong Cho, Anyang-si (KR)

(73) Assignee: LG ELECTRONICS INC., Seoul (KR)

(21) Appl. No.: 14/117,325

(22) PCT Filed: May 25, 2012
(86) PCT No.: PCT/KR2012/004165

§ 371 Date: Nov. 12, 2013

Related U.S. Application Data
(60) Provisional application No. 61/489,697, filed on May 25, 2011.
(60) Provisional application No. 61/508,052, filed on Jul. 14, 2011.

(51) Int. Cl. H04W 68/00

(52) U.S. Cl. CPC H04W 68/00
USPC 455/458

(57) ABSTRACT

According to a first embodiment disclosed in the present description, a method for receiving a paging message of a first base station by a terminal which can transceive data to/from the first base station that supports a first radio access technology (RAT) and a second base station that supports a second radio access technology, in a wireless access system that supports a multi-radio access technology, comprises the steps of: establishing a connection to the first base station; receiving, from the first base station, a second base station connection command message including a paging message transmission indication; establishing a connection to the second base station in response to the second base station connection command message; and monitoring a paging message of the first base station on the basis of the paging message transmission indication using either the first base station or the second base station.

### TECHNICAL FIELD

The disclosure relates to a radio access system supporting a multi radio access technology (Multi RAT) and, more particularly, to a method and apparatus for efficiently performing paging.

### BACKGROUND ART

Conventionally, in a wireless communication environment supporting two or more heterogeneous networks, even if a mobile station has multi radio access technology (RAT) capability, the mobile station cannot simultaneously access a multi RAT network and thus the mobile station cannot simultaneously transmit and receive data to and from two or more heterogeneous networks.

That is, a mobile station supporting conventional multi RAT accesses any one RAT network based on switching, and transmits and receives data through one network. Thus, when the mobile station having the multi RAT capability transmits and receives data through a specific network and then transmits and receives data to and from another network different from the specific network, transmission and reception of data to and from any one network are stopped.

Thus, conventionally, a mobile station having capability for supporting two or more heterogeneous networks can perform communication through different networks. However, since the mobile station operates based on simple switching, the mobile station has limited efficiency. In addition, different networks operate independently of each other and thus the mobile station operates inefficiently in terms of overall flow management thereof.

In order to solve the above problem, a method of a mobile station having a multi RAT capability simultaneously transmitting and receiving data through two or more heterogeneous networks (a primary system and a secondary system), i.e. through each network, has been defined. According to the above-defined method, an indirect scheme to improve network/user performance, network capability, and user service quality is provided. For example, the mobile station having the multi RAT capability communicates with two access points. One is an access point of IEEE 802.11 and the other is an access point of IEEE 802.16. In addition, for example, the mobile station having the multi RAT capability may communicate with an integrated device having both an IEEE 802.16 interface and an IEEE 802.11 interface.

In general, the mobile station having the multi RAT capability may transmit and receive data corresponding to a specific service flow to and from the secondary system under control of the primary system. In the above-defined method, however, there is no definition as to whether the mobile station simultaneously using the network of the primary system and the network of the secondary system continuously monitors the network of the primary system in a case in which there is data traffic transmitted through the primary system but there is no data traffic transmitted through the secondary system.

### DISCLOSURE

### Technical Problem

An object of the disclosure devised to solve the problem lies in providing a method of defining a status of a mobile station having multi, i.e. two or more, MAC/PHY layers, specifically an idle mode, and efficiently receiving a paging message and a mobile station using such a method.

### Technical Solution

The object of the disclosure can be achieved by providing a method of a mobile station receiving a paging message of a primary base station, the mobile station being capable of transmitting and receiving data to and from the primary base station supporting a primary radio access technology (RAT) and a secondary base station supporting a secondary RAT in a radio access system supporting a multi RAT according to a first embodiment of the disclosure, the method including establishing association with the primary base station, receiving a secondary base station association command message including a paging message transmission indication from the primary base station, establishing association with the secondary base station in response to the secondary base station association command message, and monitoring the paging message of the primary base station through the primary base station or the secondary base station based on the paging message transmission indication.

In an embodiment, the monitoring step may include receiving a paging message indication from the secondary base station and receiving the paging message from the primary base station.

In addition, in an embodiment, the monitoring step may include receiving a paging message from the secondary base station.

In addition, in an embodiment, the monitoring step may include receiving an indication of network reentry into the primary base station from the secondary base station. In addition, in an embodiment, the method may further include performing network reentry into the primary base station in response to the network reentry indication.

In addition, in an embodiment, the monitoring step may include receiving a paging message or a paging indication message from a paging controller or the primary base station through the secondary base station. In addition, in an embodiment, the monitoring step may further include, upon receiving a message corresponding to an IP address of the paging controller or an IP address of the primary base station, recognizing the received message as a paging message.

In addition, in an embodiment, location update for the primary base station may not be performed during association with the secondary base station.

In addition, in an embodiment, the method may further include performing data communication with the secondary base station and, upon completion of data communication with the secondary base station in an idle mode, informing the primary base station of paging message monitoring from the primary base station.

In addition, in an embodiment, the informing step may include performing location update for the primary base station.

In addition, in an embodiment, the secondary base station association command message may include AAI-SS-CMD.

In addition, in an embodiment, the method may include, before the monitoring step, receiving a message related to entry into an idle mode from the primary base station and entering the idle mode in response to the message related to entry into the idle mode.

In addition, in an embodiment, the method may further include, before the monitoring step, performing data communication with the secondary base station and performing deregistration from the primary base station.

In addition, in an embodiment, the primary RAT may include a wide band RAT and the secondary RAT may include a local area RAT. In addition, in an embodiment, the wide band RAT may include a RAT supporting 802.16 and the local area RAT may include a RAT supporting 802.11.

Meanwhile, the object of the disclosure can be achieved by providing a mobile station capable of transmitting and receiving data to and from the primary base station supporting a primary radio access technology (RAT) and a secondary base station supporting a secondary RAT in a radio access system supporting a multi RAT according to a first embodiment of the disclosure, the mobile station including a radio frequency unit for transmitting and receiving a radio signal to and from an external device and a controller connected to the radio frequency unit, wherein the controller establishes association with the primary base station, controls the radio frequency unit to receive a secondary base station association command message comprising a paging message transmission indication from the primary base station, and monitors a paging message of the primary base station through the primary base station or the secondary base station based on the paging message transmission indication.

Meanwhile, the object of the disclosure can be achieved by providing a method of a mobile station receiving a paging message of a primary base station, the mobile station being capable of transmitting and receiving data to and from the primary base station supporting a primary radio access technology (RAT) and a secondary base station supporting a secondary RAT in a radio access system supporting a multi RAT according to a first embodiment of the disclosure, the method including receiving a message related to entry into an idle mode comprising a paging message transmission indication from the primary base station, entering the idle mode in response to the message related to entry into the idle mode, and monitoring the paging message of the primary base station through the primary base station or the secondary base station based on an indication indicating whether the paging message will be monitored.

In an embodiment, the monitoring step may include receiving a paging message indication from the secondary base station and receiving the paging message from the primary base station.

In addition, in an embodiment, the monitoring step may include receiving a paging message from the secondary base station.

In addition, in an embodiment, the message related to entry into the idle mode may include AAI-DREG-RSP.

### Advantageous Effects

According to embodiments of the disclosure, it is possible for a mobile station having multi, i.e. two or more, MAC/PHY layers, to efficiently receive a paging message.

### DESCRIPTION OF DRAWINGS

FIGS. 1A and 1B are conceptual views showing a multi radio access technology (Multi RAT) network to which an embodiment of the disclosure may be applied.

FIG. 2 is a flowchart showing a method of a multi RAT mobile station transmitting and receiving data through a primary system and a secondary system.

FIG. 3 is a flowchart showing a multi RAT capability negotiation procedure between the multi RAT mobile station and the primary system.

FIG. 4 is a flowchart showing a scanning procedure of the multi RAT mobile station on the secondary system.

FIG. 5 is a flowchart showing a procedure of adding a secondary system in a secondary system management method, i.e. a procedure in which the multi RAT mobile station accesses the secondary system.

FIG. 6 is a flowchart showing a procedure in which the multi RAT mobile station is associated with the secondary system.

FIG. 7 is a flowchart showing a procedure in which the multi RAT mobile station is reassociated with the secondary system.

FIG. 8 is a flowchart showing a procedure in which the multi RAT mobile station is disassociated from the secondary system.

FIG. 9 is conceptual view showing a multi radio access technology (Multi RAT) network to which an embodiment of the disclosure may be applied.

FIG. 10 is a view showing a procedure in which a multi RAT mobile station according to an embodiment of the disclosure is associated with a secondary system.

FIG. 11 is a view showing a mobile station idle mode entry procedure commenced by a mobile station according to an embodiment of the disclosure.

FIGS. 12A and 12B are views showing a mobile station idle mode entry procedure commenced by a base station according to an embodiment of the disclosure.

FIG. 13 is conceptual view showing a multi radio access technology (Multi RAT) network to which another embodiment of the disclosure may be applied.

FIG. 14 is a conceptual view showing a procedure in which a multi RAT mobile station according to an embodiment of the disclosure receives a paging message through a secondary system.

FIGS. 15A and 15B are conceptual views showing a procedure in which a multi RAT mobile station according to an embodiment of the disclosure transmits a paging message through a secondary system.

FIG. 16 is an internal block diagram of a mobile station and base stations in a radio access system to which embodiments of the disclosure may be applied.

### BEST MODE

The following technologies may be used in various wireless communication systems such as code division multiple access (CDMA), frequency division multiple access (FDMA), time division multiple access (TDMA), orthogonal frequency division multiple access (OFDMA), and single carrier frequency division multiple access (SC-FDMA).

CDMA may be implemented as a radio technology such as universal terrestrial radio access (UTRA) or CDMA2000. TDMA may be implemented as a radio technology such as global system for mobile communications (GSM), general packet radio service (GPRS), and enhanced data rates for GSM evolution (EDGE). OFDMA may be implemented as radio technology such as institute of electrical and electronics engineers (IEEE) 802.11 (Wi-Fi), IEEE 802.16 (WiMAX), IEEE 802.20, and evolved-UTRA (E-UTRA). IEEE 802.16m is an evolved version of IEEE 802.16e and provides backward compatibility with a system based on IEEE 802.16e.

UTRA is a part of universal mobile telecommunication system (UMTS).

Third generation partnership project (3GPP) long term evolution (LTE) is a part of evolved UMTS (E-UMTS) using evolved-UMTS terrestrial radio access (E-UTRA) and employs OFDMA on downlink and SC-FDMA on uplink. LTE-advanced (LTE-A) is an evolved version of 3GPP LTE.

Hereinafter, the disclosure will be described in detail by explaining exemplary embodiments of the invention with reference to the accompanying drawings. The same reference numerals in the drawings denote like elements, and a repeated explanation thereof will not be given. In the description of the disclosure, certain detailed explanations of the related art are omitted when it is deemed that they may unnecessarily obscure the essence of the invention. The features of the disclosure will be more clearly understood from the accompanying drawings and should not be limited by the accompanying drawings. It is to be appreciated that all changes, equivalents, and substitutes that do not depart from the spirit and technical scope of the disclosure are encompassed in addition to the accompanying drawings in the disclosure.

Hereinafter, a method in which, in a multi RAT network proposed in the disclosure, a mobile station accesses two or more heterogeneous networks (or the multi RAT network) and simultaneously transmits and receives data through the networks will be described.

### Multi Radio Access Technology (RAT) Network

First, a multi RAT network, to which an embodiment of the disclosure may be applied, will be described below.

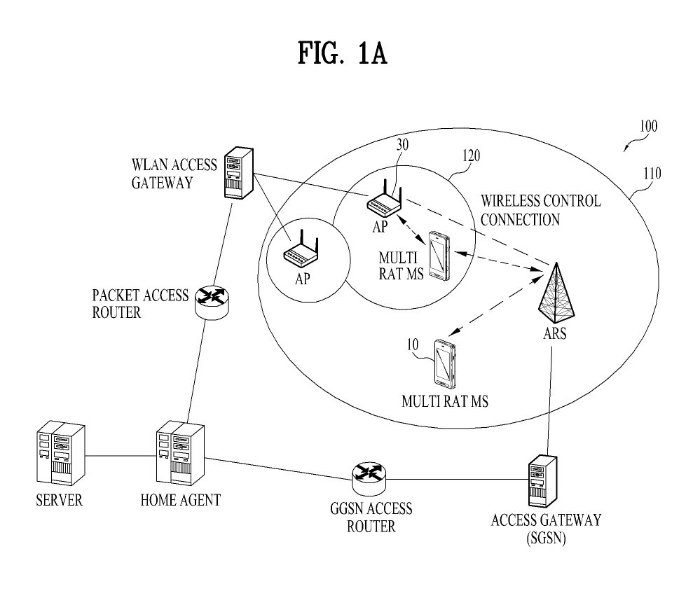

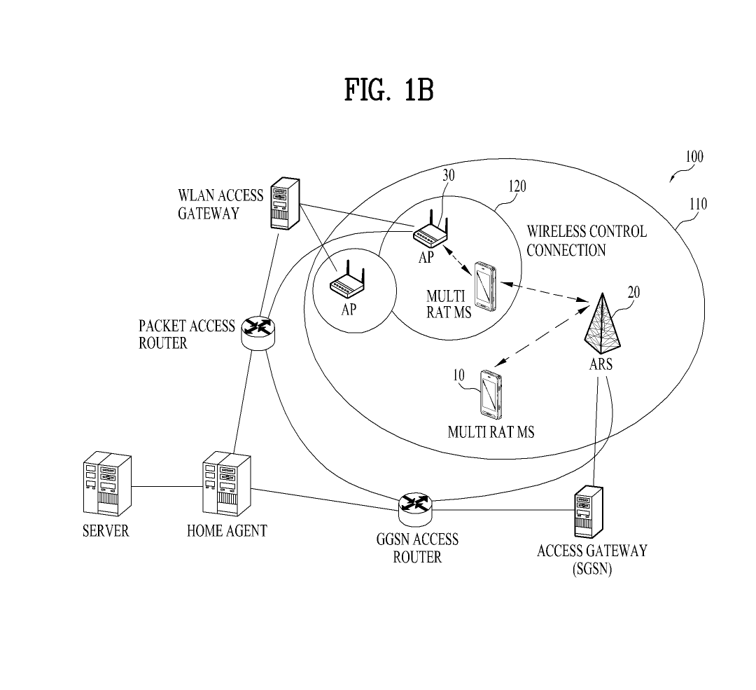

FIGS. 1A and 1B are conceptual views showing a multi radio access technology (Multi RAT) network to which an embodiment of the disclosure may be applied.

A multi radio access technology (hereinafter, referred to as a multi RAT) network refers to a wireless communication environment in which two or more heterogeneous networks coexist and a mobile station accesses the two or more heterogeneous networks to simultaneously perform communication.

Here, a mobile station that is capable of simultaneously communicating with two or more heterogeneous networks may also be referred to as a ‘multi RAT mobile station’ or a ‘multi system mobile station’.

In a specific network, a heterogeneous network (or a heterogeneous system) refers to a network using a communication method different from a communication method used in the specific network.

For example, a worldwide interoperability for microwave access (WiMAX) network and a wireless fidelity (WiFi) network as an example of a mobile communication system correspond to heterogeneous networks.

RAT is a technology type used in radio access. Examples of RAT may include GSM/EDGE radio access network (GERAN), UMTS terrestrial radio access network (UTRAN), evolved-UMTS terrestrial radio access network (E-UTRAN), WiMAX, LTE(-A), and WiFi. That is, GERAN, UTRAN, E-UTRAN, WiMAX, and/or WiFi coexist in the same area.

As shown in FIGS. 1A and 1B, a multi RAT network 100 may include a primary system 110 and a secondary system 120.

Here, the primary system 110 and the secondary system 120 may be referred to as a primary network and a secondary network, respectively. The primary system 110 may include a multi RAT mobile station 10, a base station 20, and the secondary system 120. The secondary system 120 may include the multi RAT mobile station 10 and an access point (AP) 30.

The primary system may have coverage of a wide range and may be a mobile communication system. In addition, the primary system may have a function to transmit control information. For example, the primary system may be a WiMAX or LTE(-A) system. In addition, the primary system is always in a predetermined status with respect to the multi RAT mobile station. That is, the primary system maintains an active status, a sleep mode status, or an idle mode status with respect to the multi RAT mobile station. The multi RAT mobile station may be first associated with the primary system.

The secondary system may have coverage of a small range and may be a wireless local area network (WLAN) system. In addition, the secondary system may have a function to transmit data. For example, the secondary system may be a Wi-Fi system. That is, the secondary system may be added to or deleted from the multi RAT network as needed. In addition, the secondary system may be used for data transmission and reception which mainly requires a higher bandwidth (BW). Thus, mapping may be performed on a specific flow (quality of service (QoS)) in order to use the secondary system. Association or disassociation between the secondary system and the multi RAT mobile station may be performed after checking from the primary system.

That the multi RAT mobile station is associated with the secondary system may mean that the multi RAT mobile station is ready to transmit and receive data to and from the secondary system or that the multi RAT mobile station transmits and receives data to and from the secondary system. Upon detecting that the multi RAT mobile station enters the coverage of the secondary system, the multi RAT mobile station may receive information about access to the secondary system from the primary system. In this case, real data transmission and reception may not be immediately performed. In addition, in a case in which the multi RAT mobile station has data to be transmitted and received through the secondary system, the multi RAT mobile station may receive access information about a corresponding flow from the primary system. In this case, real data transmission and reception may be immediately performed.

Herein, the AP, as an example of a base station of the secondary system, may operate in the same way as a mobile station capable of communicating with the primary system.

In addition, the primary system and the secondary system are connected to each other in a wired or wireless manner in the multi RAT network. That is, a base station of the primary system and a base station of the secondary system may be connected to each other through a backbone network in a wired manner (FIG. 1B) or in a wireless manner (FIG. 1A).

Hereinafter, for the convenience of description, it will be assumed that the primary system is a WiMAX system and the secondary system is a Wi-Fi system unless otherwise mentioned. Accordingly, a base station corresponding to the primary system will be referred to as a ‘BS’ or an ‘ABS’ and a base station corresponding to the secondary system will be referred to as an ‘AP’. In addition, hereinafter, access to the primary system may have the same meaning as access to the base station (or the ABS) and access to the secondary system may have the same meaning as access to the AP.

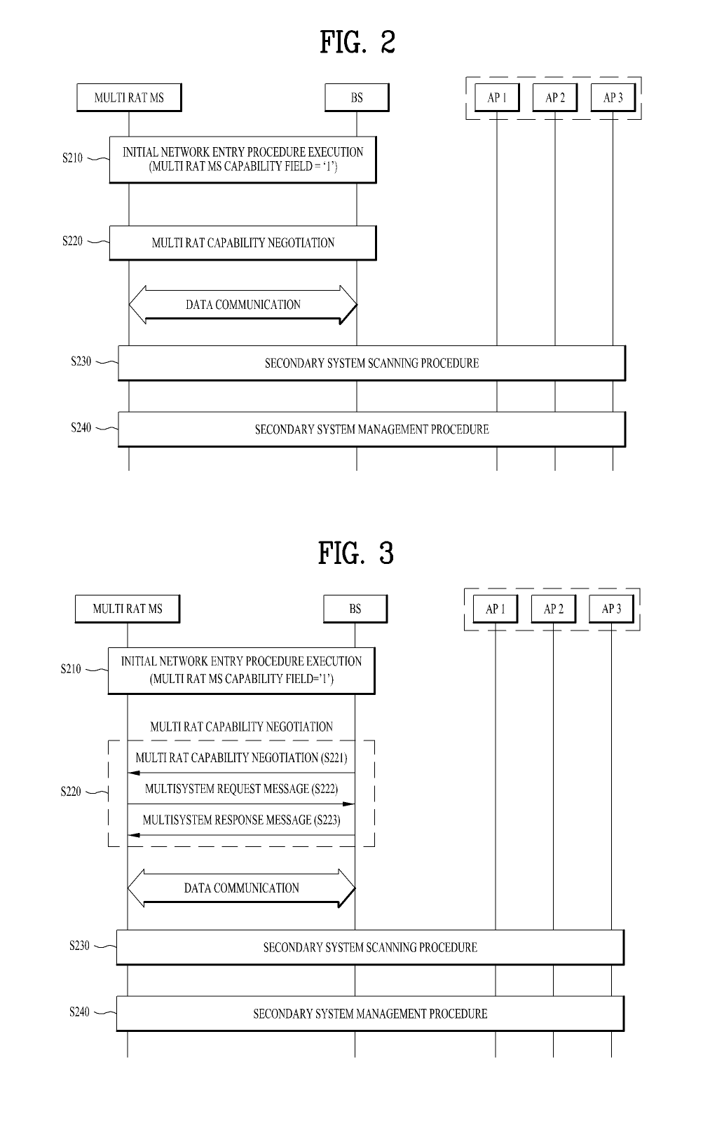

FIG. 2 is a flowchart showing a method of a multi RAT mobile station transmitting and receiving data through a primary system and a secondary system.

Referring to FIG. 2, the multi RAT mobile station executes an initial network entry procedure to a base station (S210).

The multi RAT mobile station transmits an indicator indicating that the multi RAT mobile station supports multi RAT to the base station through the initial network entry procedure to the base station. Here, the indicator may be a multi RAT mobile station capability field. In addition, the indicator, i.e. the multi RAT mobile station capability field, may have a size of 1 bit.

In addition, the indicator may be transmitted through a registration procedure performed during the initial network entry procedure to the base station. In this case, the indicator may be transmitted to the base station through a registration request or registration response message (REG-REQ/RSP message).

For example, when the indicator is set to ‘1’, the indicator indicates that the multi RAT mobile station supports multi RAT. When the indicator is set to 0′, on the other hand, the indicator indicates that the multi RAT mobile station does not support multi RAT.

In addition, when the base station receives a registration request or registration response message including an indicator (e.g., an indicator set to ‘1’) indicating that the multi RAT mobile station has capability for supporting multi RAT from the multi RAT mobile station, the base station may transmit, to the multi RAT mobile station, notification information indicating that a separate multi RAT capability negotiation procedure for supporting the multi RAT mobile station will be performed after the initial network entry procedure is completed or a predetermined time elapses.

For example, when the notification information is set to ‘1’, the notification information indicates that the base station and the multi RAT mobile station perform the separate multi RAT capability negotiation procedure in order to support multi RAT. When the notification information is set to ‘0’, on the other hand, the notification information indicates that the separate multi RAT capability negotiation procedure does not have to be performed.

Subsequently, when the multi RAT mobile station and the base station complete the initial network entry procedure, the multi RAT mobile station and the base station perform a multi RAT capability negotiation procedure (S220). In general, the multi RAT capability negotiation procedure is performed after a network (re-)entry procedure is completed. However, the multi RAT capability negotiation procedure may also be performed during the network (re-)entry procedure to the base station.

For example, when the multi RAT capability negotiation procedure is performed during the network (re-)entry procedure, the multi RAT mobile station and the base station may perform the multi RAT capability negotiation procedure through a registration procedure of the base station and the multi RAT mobile station. In this case, the multi RAT mobile station and the base station may transmit and receive information about multi RAT capability negotiation through the registration request/registration response (REG-REQ/REG-RSP) message.

The multi RAT capability negotiation procedure of the multi RAT mobile station and the primary system will hereinafter be described in detail with reference to FIG. 3.

Subsequently, the multi RAT mobile station performs an AP scanning procedure for access to the secondary system based on information related to the secondary system received from the base station (S230).

Here, the multi RAT mobile station performs a scanning procedure on peripheral APs periodically or in an event-triggered manner in order to access the secondary system.

First, it is assumed that connection of all data transmitted to the multi RAT mobile station is performed using a dynamic service (DSx) procedure with the base station of the primary system and communication between the secondary system and the multi RAT mobile station is performed by transmitting data for a specific flow to the secondary system based on determination of the base station of the primary system.

In addition, it is assumed that the scanning of the multi RAT mobile station on the AP of the secondary system is performed according to an indication of the base station of the primary system for power saving of the multi RAT mobile station.

The AP scanning procedure of the multi RAT mobile station for the access to the secondary system may include receiving a multi RAT scan command message from the base station, performing scanning based on the received multi RAT scan command message, and transmitting a multi RAT scan report message for reporting a scanning result to the base station.

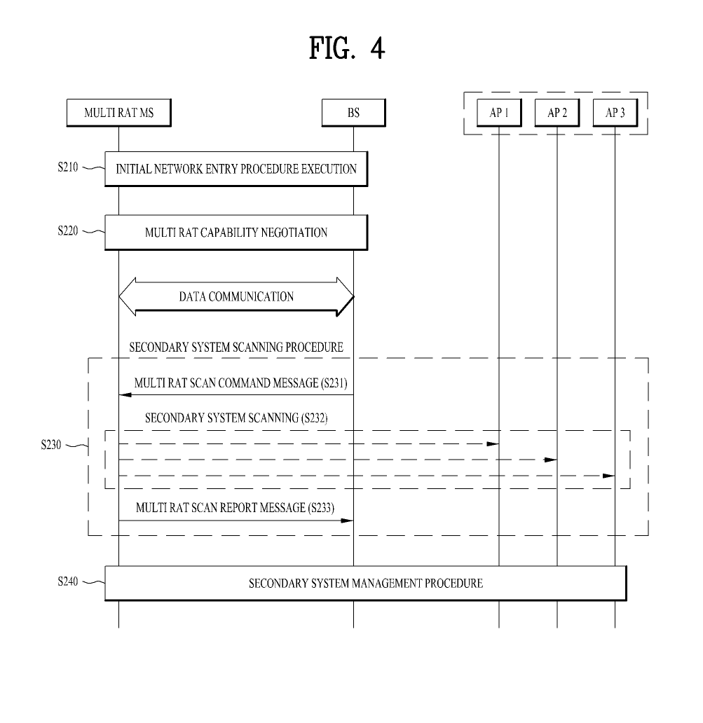

The scanning procedure of the multi RAT mobile station for the access to the secondary system will hereinafter be described in detail with reference to FIG. 4.

Subsequently, the multi RAT mobile station performs a secondary system management (or operation) procedure (S240). Here, the secondary system management procedure refers to a procedure such as association, disassociation, or association switching between the multi RAT mobile station and the secondary system. Here, the secondary system management procedure is controlled by the primary system.

After the multi RAT mobile station accesses the secondary system, the multi RAT mobile station transmits and receives data through the AP of the secondary system.

Here, the multi RAT mobile station needs to receive acknowledgement about the access to the secondary system from the primary system in order to access the secondary system.

That is, as described above, the base station selects an AP which the multi RAT mobile station accesses and checks a state of the selected AP prior to transmission of the acknowledgement about the access of the multi RAT mobile station to the secondary system to the multi RAT mobile station. As the check result, when the selected AP can be accessed, the base station may transmit information about the multi RAT mobile station to the selected AP in advance.

In addition, when the base station transmits the acknowledgement to the multi RAT mobile station, the base station may also transmit information necessary or useful for the access of the multi RAT mobile station to the AP.

For example, the necessary or useful information may be subsystem identification (SSID), a media access control (MAC) address of the AP, a wired equivalent privacy (WEP) key, a channel number (i.e. frequency information), a protocol version (11a/b/n . . . ) of the AP, or offset information between a beacon and a frame of the base station (which is transmitted as a difference from a specific frame time that represents a relative position of the beacon).

In addition, as a result of the AP scanning of the multi RAT mobile station for the access to the secondary system, when the multi-AP mobile station recognizes that the multi-AP mobile station enters the coverage of the secondary system, the multi RAT mobile station may request the base station of the primary system for the access to the secondary system.

The secondary system management procedure may include the following messages.

1. A secondary system request (SS_REQ) message

: which is used for the multi RAT mobile station to request access to the AP.

2. A secondary system command (SS_CMD) message

: which is a message used to manage the access to the AP and is used for association, disassociation, or association switching between the multi RAT mobile station and the AP.

3. A secondary system indication (SS_IND) message

: which is a message used as a response to the secondary system command message and is used for the multi RAT mobile station to inform the base station about success in association, disassociation, or association switching between the multi RAT mobile station and the AP.

Subsequently, when the access to the AP of the secondary system is successful, the multi RAT mobile station may transmit and receive data to and from the primary system and, at the same time, may also transmit and receive data to and from the secondary system. Here, the data transmitted and received to and from the multi RAT mobile station through the AP are controlled by the primary system.

Multi RAT capability negotiation procedure

Hereinafter, the multi RAT capability negotiation procedure between the multi RAT mobile station and the base station will be described in detail.

FIG. 3 is a flowchart showing the multi RAT capability negotiation procedure between the multi RAT mobile station and the primary system.

Operations S210, S230, and S240 are the same as in FIG. 2 and thus a detailed description thereof will be omitted. Only operation S220, which is different from in FIG. 2, will be described in detail.

As described above, the multi RAT capability negotiation procedure between the multi RAT mobile station and the base station is performed after the network (re-)entry procedure is completed.

In case of the network reentry procedure, the multi RAT capability negotiation procedure may be omitted. This is because the multi RAT capability has already been negotiated through the initial network entry procedure between the multi RAT mobile station and the base station and thus unnecessary overhead is created if the multi RAT mobile station performs the same procedure when the multi RAT mobile station re-enters a network of the same system.

In addition, during handover (HO), a target base station of the primary system may negotiate with the multi RAT mobile station for the multi RAT capability in advance through a backbone network from a serving base station of the primary system.

The multi RAT mobile station may perform the multi RAT capability negotiation procedure with the primary system as follows.

First, the base station may transmit information related to the secondary system to the multi RAT mobile station (S221). That is, when there is common information about APs of the secondary system, which needs to be received by the multi RAT mobile station, the base station may transmit the AP information to the multi RAT mobile station in a broadcast or unicast manner.

The information related to the secondary system refers to information about a heterogeneous system located within the same coverage as the primary system. Here, the multi RAT mobile station may not have to know all secondary systems included in the primary system and information related to the secondary systems. In this case, the base station may not transmit the secondary systems and the information related to the secondary systems but may transmit only a list of information related to (or necessary for) the multi RAT mobile station to the multi RAT mobile station in a unicast manner. In this case, the list may be transmitted during the multi RAT capability negotiation procedure.

Subsequently, the multi RAT mobile station transmits a multisystem capability request message to the base station (S222). The multisystem capability request message may include, for example, an 802.11 MAC address of the multi RAT mobile station, conventional access AP information (information about the AP preferred by the mobile station), 802.11 protocol version information, and traffic characteristics for communication using 802.11. The 802.11 MAC address is required for authentication information. When the conventional access AP information is included in the multisystem capability request message, the multisystem capability request message is transmitted only to a base station to which a conventional access AP belongings.

Subsequently, the base station transmits a multisystem capability response message to the multi RAT mobile station in response to the multisystem capability request message (S223).

The multisystem capability response message may include information about candidate APs. When the network reentry is performed, the multi RAT capability negotiation procedure may be omitted. In addition, when the multi RAT mobile station performs handover, the multi RAT mobile station may perform the capability negotiation procedure in advance through the backbone network from the serving base station.

In addition, when the multi RAT mobile station enters an idle mode, the base station may store information obtained through the multi RAT capability negotiation procedure with the multi RAT mobile station for a predetermined period of time. That is, a new period of time is set by a multi RAT information latch timer. The obtained information may be stored until the time set by the multi RAT information latch timer elapses. After the time set by the multi RAT information latch timer elapses, the obtained information may be discarded.

Consequently, the multi RAT capability negotiation procedure may be omitted when the multi RAT mobile station re-enters the network of the base station before the time set by the multi RAT information latch timer elapses.

### Secondary System Scanning Procedure

Hereinafter, a scanning procedure of the multi RAT mobile station on the secondary system will be described in detail.

FIG. 4 is a flowchart showing a scanning procedure of the multi RAT mobile station on the secondary system.

Operations S210, S220, and S240 are the same as in FIG. 2 and thus a detailed description thereof will be omitted. Only operation S230, which is different from in FIG. 2, will be described in detail.

First, the base station may commence scanning on the secondary system according to a command thereof in an unsolicited manner. In this case, the base station requests scanning when the base station determines that a specific data flow needs to be transmitted and received using WiFi or when a favorite AP is registered with a cell of the base station. In this case, the base station commands the multi RAT mobile station to scan peripheral APs.

That is, the base station transmits a multi RAT scan command message (Multi RAT_SCN-CMD message) or AAI_SCN-RSP to the multi RAT mobile station (S231). In this case, the multi RAT scan command message and AAI_SCN-RSP may include SSIDs of the peripheral APs, a beacon transmission period, and scanning interval information in order for the multi RAT mobile station to quickly detect the peripheral APs. In addition, the multi RAT scan command message and AAI SCN-RSP may include BSSType (infrastructure BSS, IBSS, or both), BSSID, SSID, scan type (active or passive), ProbeDelay (delay time used before transmission of a probe frame), ChannelList, and MinMax Channel Time.

Alternatively, the base station transmits MULTIRAT_SCAN_DEADLINE to the multi RAT mobile station. If the base station does not receive a response message, such as SCN-REP, within MULTIRAT_SCAN_DEADLINE after the base station commands the multi RAT mobile station to perform the scanning procedure, the base station performs transmission and reception of data for a corresponding flow through the primary system.

Here, in order to perform the scanning procedure, the multi RAT mobile station may directly request the base station of the primary system for scanning for access to the secondary system, but not in response to the indication of the base station as described above. In this case, the multi RAT mobile station and the base station may perform the scanning procedure on the peripheral APs through a probe request/response transmitting/receiving procedure.

Here, the multi RAT mobile station may also perform the scanning procedure for the access to the secondary system during transmission and reception of data to and from the base station of the primary system. In this case, the multi RAT mobile station may indicate only a scan report (SCN-REP) transmission method through a scan command (SCN-CMD) message without setting a scanning interval with the base station.

That is, when the multi RAT mobile station receives the multi RAT scan command message from the base station, the multi RAT mobile station performs the scanning procedure on the peripheral APs of the multi RAT mobile station through reception of a beacon from the AP or transmission and reception of the probe request/response based on information included in the received multi RAT scan command message (S232). Here, the peripheral APs of the multi RAT mobile station may be APs of the secondary system within the coverage of the base station of the primary system.

Subsequently, the multi RAT mobile station transmits a multi RAT scan report message (MultiRAT_SCN-REP message) or AAI_SCN-REP to the base station of the primary system (S233). That is, the multi RAT mobile station transmits the scanning result of the detected AP to the base station. In this case, the multi RAT mobile station may transmit a receive signal intensity indicator (RSSI) of each AP or favorite AP information of the multi RAT mobile station together.

The scan report message or AAI_SCN-REP may be transmitted, for example, once, periodically, based on an event trigger, or based on a trigger condition under indication of the CMD message. In addition, in this case, the multi RAT mobile station may transmit the scanning result of the AP to the base station according to definition of an AP specified trigger condition. Here, the AP specified trigger condition may be defined per flow.

For example, when a scan report mode in a multi RAT scan command message that has been most recently received from the base station is set to ‘0b10’, the multi RAT mobile station may transmit the multi RAT scan report message to the base station in an event-triggered manner.

In this case, when the multi RAT mobile station satisfies a scan report trigger condition, the multi RAT mobile station transmits the multi RAT scan report message to the base station.

As another example, the multi RAT mobile station may report the scanning result to the base station at a time specified in the multi RAT scan command message, but not within the scanning interval, for periodic scan report (for example, when a scan report mode is set to ‘Ob01’) or one scan report (for example, when the scan report mode is set to ‘0b11’).

In addition, when the multi RAT mobile station periodically reports the scanning result to the base station, the multi RAT mobile station may stop reporting the scanning result of APs after all scanning intervals in the multi RAT scan command message.

In addition, the multi RAT scan report message may include all available scanning results of requested APs specified in the multi RAT scan command message.

The multi RAT mobile station may transmit the multi RAT scan report message to the base station in order to report the scanning result to the base station anytime or to receive system information about a requested system and to selectively receive a multi RAT neighbor advertising message, which includes system information about other RATs that are determined by the base station to exist in the vicinity of the multi RAT mobile station, from the base station in a unicast manner.

Furthermore, the multi RAT mobile station may add a neighbor request RAT type indicator and/or SSIDs (or BSSID or MAC address) to the scan report message and thus the multi RAT mobile station may request the base station to filter a list of neighbor secondary systems in order to filter the list based on a requested wireless type.

Subsequently, when the base station receives scanning results of a plurality of APs from the multi RAT mobile station, i.e. when the base station receives the multi RAT scan report message, the base station may select an optimal system, i.e. an optimal AP, in consideration of the same operator, mobile station priority, channel quality, load balancing, transmission traffic, or the like, and may inform the multi RAT mobile station of the selected optimal system.

According to another embodiment of the disclosure, the multi RAT mobile station may use a conventional message that is transmitted and received instead of the multi RAT scan command/report messages defined above in order to perform the scanning procedure on the secondary system. Here, when the multi RAT mobile station scans the secondary system using the conventional message, the conventional message includes information indicating that the scanning procedure of the multi RAT mobile station is performed to transmit and receive data using the multi RAT system. That is, a new field indicating an SSID, BSSID, or MAC address of a target system may be defined in the conventional message so as to indicate a target to be scanned by the multi RAT mobile station.

Subsequently, the multi RAT mobile station accesses the secondary system and then transmits and receives data to and from the secondary system. Here, association, disassociation, or association switching between the multi RAT mobile station and the secondary system may correspond to the secondary system management (or operation) procedure. In addition, the primary system may control the secondary system management.

Here, in order to access the secondary system, the multi RAT mobile station needs to receive acknowledgement about the access to the secondary system from the primary system.

That is, as described above, the base station selects an AP which the multi RAT mobile station accesses and checks a status of the selected AP prior to transmission of the acknowledgement about the access to the secondary system to the multi RAT mobile station. As the check result, when the selected AP can be accessed, the base station may transmit information about the multi RAT mobile station to the selected AP in advance.

In addition, when the base station transmits the acknowledgement to the multi RAT mobile station, the base station may also transmit information necessary or useful for the access of the multi RAT mobile station to the AP.

For example, the necessary or useful information may be SSID, a MAC address of the AP, a WEP Key, a channel number (i.e. frequency information), a protocol version (11a/b/n . . . ) of the AP, or offset information between a beacon and a frame of the base station (which is transmitted as a difference from a specific frame time that represents a relative position of the beacon).

In addition, as a result of the AP scanning of the multi RAT mobile station for the access to the secondary system, when the multi-AP mobile station recognizes that the multi-AP mobile station enters the coverage of the secondary system, the multi RAT mobile station may request the base station of the primary system for the access to the secondary system.

### Secondary System Management

Hereinafter, a secondary system management (or operation) method will be described in detail. Here, the secondary system management refers to association or disassociation between the secondary system and the multi RAT mobile station and association switching between the multi RAT mobile station and the secondary system. The secondary system management is controlled by the base station, i.e. the primary system.

As an example of the secondary system management method, a procedure in which the multi RAT mobile station accesses (or is associated with) the secondary system, i.e. a procedure in which the multi RAT mobile station simultaneously transmits and receives data to and from both the primary system and the secondary system through addition of the secondary system, will hereinafter be described.

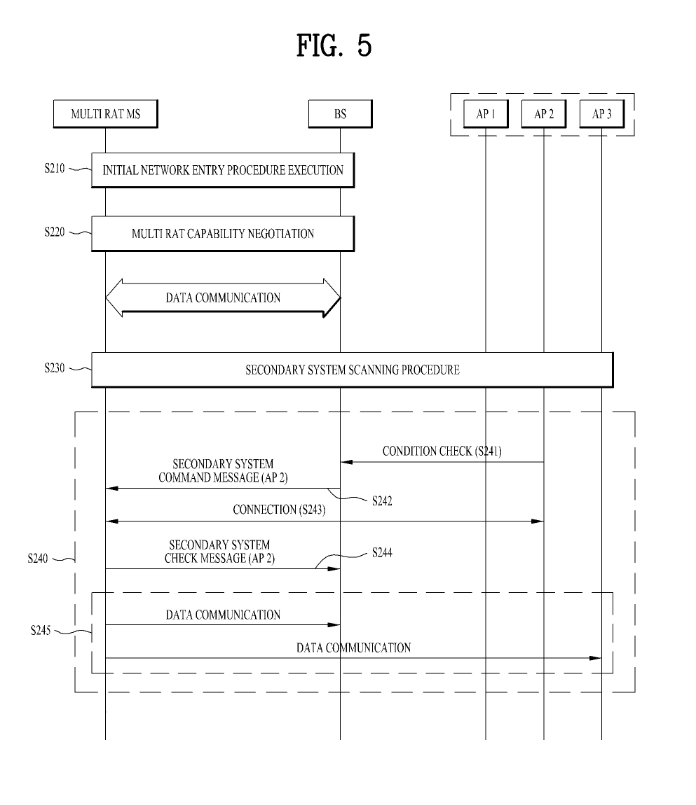

FIG. 5 is a flowchart showing a procedure of adding the secondary system in the secondary system management method, i.e. a procedure in which the multi RAT mobile station accesses the secondary system.

Operations S210 to S230 are the same as in FIG. 2 and thus a detailed description thereof will be omitted. Only operation S240, which is different from in FIG. 2, will be described in detail.

For access to the secondary system, the multi RAT mobile station or the base station may request multi RAT access. In this case, the multi RAT access request procedure may be performed through a secondary system access request/response message.

The secondary system may be added as follows according to request of the multi RAT mobile station. In a case in which the multi RAT mobile station performs scanning to detect a secondary system satisfying a specific condition, the multi RAT mobile station may transmit a secondary system request message to the base station to request the base station for association with the secondary system.

In addition, the secondary system may be added as follows according to request of the base station. In a case in which the base station detects that a specific flow is connected to the multi RAT mobile station, the base station checks a status of an AP accessible to the multi RAT mobile station (S241).

As the check result, when access to the multi RAT mobile station is possible, the base station may transmit a secondary system command message to the multi RAT mobile station to indicate association between the multi RAT mobile station and the secondary system (S242).

Here, control for access of the multi RAT mobile station to the multi RAT network, i.e. transmission of control information, is performed by the base station of the primary system. The multi RAT mobile station merely transmits and receives data to and from the secondary system such that QoS of corresponding data follows a method supported by the primary system. In this case, the transmission of control information may be performed through a secondary system access command message.

Here, the secondary system access command message may include information about a selected AP, information about a flow transmitted to the secondary system, and an authentication method (open system or shared key). As can be seen from FIG. 5, information about the selected AP is AP 2.

Subsequently, the multi RAT mobile station completes access to a specific AP and establishing of a traffic stream (TS) while referring to the AP, information in the secondary system access command message according to a secondary system access command of the base station (S243). For example, an ADDTS request/response procedure of 802.11e may be performed.

Subsequently, the multi RAT mobile station informs the base station of success in access to the AP (S244).

As can be seen from FIG. 5, the multi RAT mobile station informs the base station of success in access to AP 2.

This may be performed through a secondary system indication (SS_IND) message. The secondary system indication message may include a mapping result between a flow ID (FID) and an association ID (AID)/a traffic stream ID (TSID) of a corresponding flow.

Subsequently, the multi RAT mobile station transmits and receives data for a specific flow through the secondary system. That is, the multi RAT mobile station simultaneously transmits and receives data to and from the primary system and the secondary system according to a data flow (S245).

That is, for DL data, the base station transmits the data to the multi RAT mobile station via the AP.

In addition, for UL data, data for a specific flow ID indicated by the base station is transmitted through a WLAN, which is an example of the secondary system.

In addition, the multi RAT mobile station may transmit and receive the secondary system command/indication message to and from the base station to perform reassociation or disassociation between the multi RAT mobile station and the AP.

In addition, in a case in which the multi RAT mobile station deviates from coverage of the WLAN, which is an example of the secondary system, and there is no peripheral AP while the multi RAT mobile station transmits and receives data to and from the AP, the base station may control seamless flow mobility between the AP and the base station such that data being transmitted and received to and from the AP can be seamlessly transmitted through the base station of the primary system.

In addition, in a case in which the multi RAT mobile station detects a neighboring AP while the multi RAT mobile station transmits and receives data to and from the AP of the secondary system, the base station may control data being transmitted and received by the multi RAT mobile station to be seamlessly transmitted and received from the AP to the neighboring AP.

In general, the WLAN, which is an example of the secondary system, is used to provide a high data rate in a small area. If the multi RAT mobile station moves at a high speed, the multi RAT mobile station may pass through small coverage of the WLAN within a short time and data communication through a procedure of establishing/releasing association with the WLAN may require the secondary system management, which is unnecessary for the multi RAT mobile station and the base station.

In order to solve the above problem, when the multi RAT mobile station satisfies certain criteria for association with the WLAN, the base station starts a timer, e.g. SecondarySystemJoin_WaitngTime, and when the timer elapses, the base station checks the criteria once again. At this time, only when the criteria are satisfied, the base station transmits a SS-CMD message about association with the WLAN to the multi RAT mobile station. Here, the criteria for association with the WLAN may include a value of a parameter related to cell characteristics, such as cell channel quality.

Hereinafter, a method of deleting (or releasing association with) the secondary system will be described.

Upon determining that a channel status of the secondary system which the multi RAT mobile station is currently accessing is poor, the multi RAT mobile station scans peripheral secondary systems. Here, as described above, scanning may be performed according to an indication of the base station or by the multi RAT mobile station.

As the result of the multi RAT mobile station scanning the peripheral secondary systems, when it is determined that no secondary system has been detected, the multi RAT mobile station is disassociated from the secondary system which the multi RAT mobile station is currently accessing.

At this time, in a case in which data corresponding to any flow of the primary system are being transmitted and received through the secondary system and the mobile station cannot perform HO to a peripheral secondary system, the base station must support multi RAT seamless flow mobility to perform seamless flow mobility without data loss of the corresponding flow.

Alternatively, at this time, in a case in which the multi RAT mobile station completes transmission of data transmitted and received to and from the secondary system, the base station may be disassociated from the secondary system.

Hereinafter, secondary system switching (for example, handover to a peripheral AP) will be described.

Here, it may be assumed that the secondary system switching, i.e. handover between secondary systems, is performed only for a specific association.

Here, the secondary system switching may be performed such that handover can be seamlessly achieved between the secondary systems through the primary system.

Upon determining that a channel status of the secondary system which the multi RAT mobile station is currently accessing is poor, the multi RAT mobile station or the base station may be disassociated from the secondary system which the multi RAT mobile station is currently accessing and request handover (HO) to another secondary system.

That is, the base station transmits an SS-CMD command to the multi RAT mobile station to inform the multi RAT mobile station that there is no more data transmission and reception through the current serving secondary system. Subsequently, the base station indicates the multi RAT mobile station to transmit and receive the conventional data through the primary system. Upon completion of the conventional data, the base station indicates the multi RAT mobile station to transmit and receive data to and from the secondary system. That is, seamless handover between the secondary systems may be performed through the primary system.

In addition, in a case in which coverage of the secondary system is over an interface between primary systems when the multi RAT mobile station performs handover between the primary systems, the multi RAT mobile station may perform seamless handover between the primary systems using the secondary system.

In addition, in a case in which the multi RAT mobile station moves at a high speed within the coverage of a WiMAX, which is an example of the primary system, the base station may indicate the multi RAT mobile station not to perform access to the secondary system although the multi RAT mobile station is located within the coverage of the secondary system. That is, the secondary system management as described above may be performed based on the speed of the multi RAT mobile station.

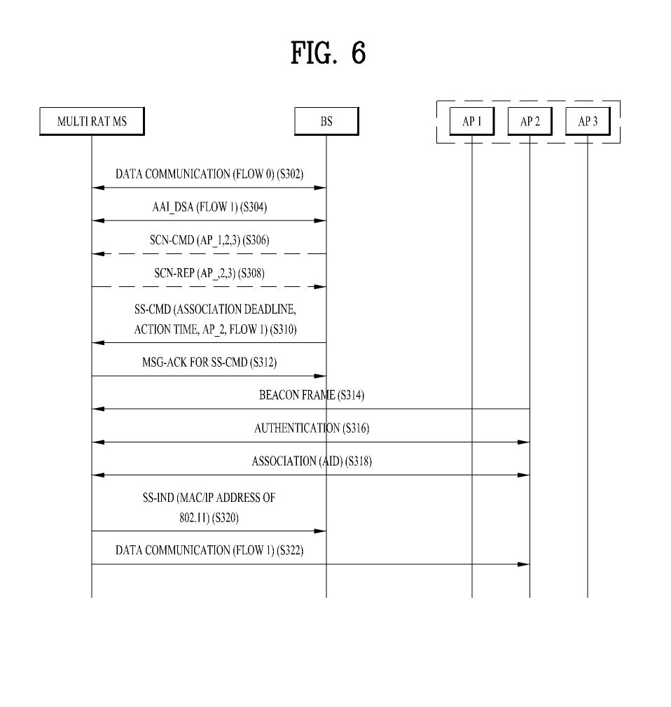

Hereinafter, a procedure in which the multi RAT mobile station is associated with, reassociated with, and disassociated from the secondary system will be described in more detail with reference to FIGS. 6 to 8.

FIG. 6 is a flowchart showing a procedure in which the multi RAT mobile station is associated with the secondary system.

The multi RAT mobile station performs data communication for flow 0 with the base station (S302). Subsequently, the multi RAT mobile station performs data communication for flow 1 with the base station through AAI_DSA (S304). In addition, the multi RAT mobile station receives a scan command message from the base station (S306), scans peripheral APs, and transmits a scan report message to the base station (S308). At this time, the base station decides to establish association between the multi RAT mobile station and a specific AP based on the scan report message.

Control for association with the AP is performed through the base station (S310). In this case, although not shown, the multi RAT mobile station may request the base station for association with the AP (for example, SS_REQ). At this time, the selected AP, information about a flow transmitted to the secondary system, and an authentication method (open system or shared key) are transmitted from the base station to the multi RAT mobile station. In addition, an SS-CMD message may include whether transition to a doze mode will be performed after association. For power saving, the base station may indicate the multi RAT mobile station to perform transition to the dose mode. In addition, the SS-CMD message may further include synchronization, authentication, and association deadline between the multi RAT mobile station and the AP and action time meaning that transmission and reception of data to and from the secondary system is possible after receiving an SS IND message, which is a value after the association deadline.

Subsequently, the multi RAT mobile station transmits a message indicating successful reception of the SS-CMD message to the base station (S312), receives a beacon from the AP indicated by the SS-CMD message to perform synchronization with the AP (S314), performs an authentication procedure using the open system or the shared key (S316), and performs association with the corresponding AP through transmission and reception of an association request/response such that an association ID (AID) is assigned to the multi RAT mobile station (S318).

The multi RAT mobile station informs the base station of successful association with the AP (S320). At this time, the multi RAT mobile station transmits a mapping result between a flow ID (FID) and an association ID (AID)/a traffic stream ID (TSID) of a corresponding flow and an IP address assigned by the AP to the base station. In a case in which the multi RAT mobile station is associated with the AP without an indication of the base station, the multi RAT mobile station must inform the base station thereof. To this end, the multi RAT mobile station may transmit the SS_IND message to the base station in an unsolicited manner.

Now, the multi RAT mobile station may transmit and receive data for a specific flow through the secondary system (S322).

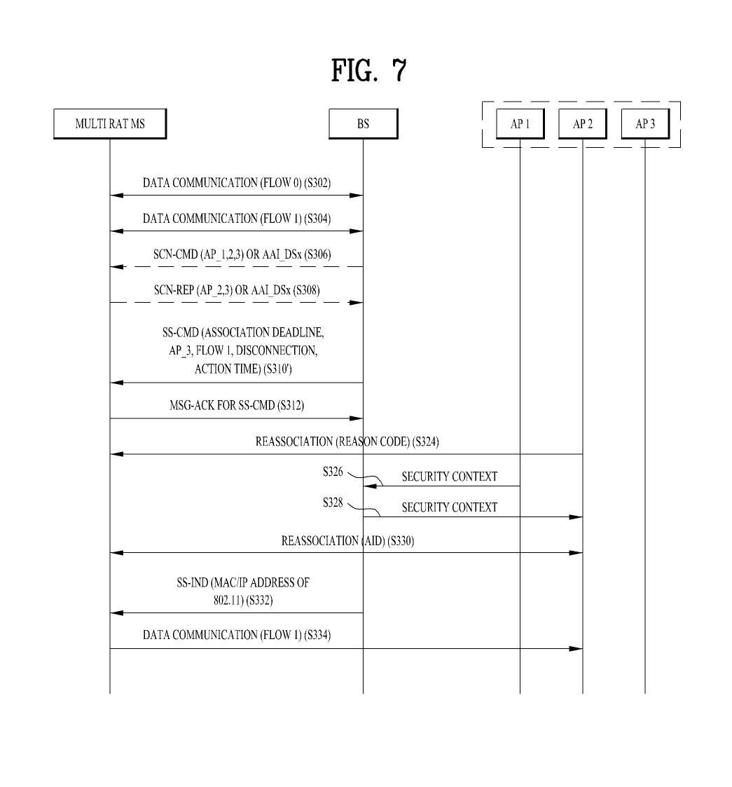

FIG. 7 is a flowchart showing a procedure in which the multi RAT mobile station is reassociated with the secondary system.

The multi RAT mobile station performs data communication for flow 0 with the base station (S302). Subsequently, the multi RAT mobile station performs data communication for flow 1 with the base station through AAI_DSA (S304). In addition, the multi RAT mobile station receives a scan command message from the base station (S306), scans peripheral APs, and transmits a scan report message to the base station (S308). At this time, the base station decides to establish reassociation (handover) from the AP associated with the multi RAT mobile station to a specific AP based on the scan report message.

The base station transmits an SS-CMD message for reassociation with the AP to the multi RAT mobile station (S310′). The SS-CMD message may include information about a flow to be transmitted to a newly selected AP and the secondary system and share key information. In addition, the SS-CMD message may further include whether the multi RAT mobile station will perform transition to a doze mode after reassociation, reassociation deadline, and disconnection and action time. In this case, the multi RAT mobile station may be disassociated from the conventional AP at the disconnection time and may start communication with the newly selected AP at the action time. In addition, this value must be a value after the reassociation deadline. The multi RAT mobile station transmits a check message indicating successful reception of the SS-CMD message to the base station (S312).

Subsequently, the multi RAT mobile station is disassociated from the conventional AP at the disconnection time and stars to communicate with the newly selected AP at the action time (S324 to S330). That is, reassociation with the new AP is performed. This procedure is achieved by the multi RAT mobile station transmitting and receiving a reassociation request/response to and from the new AP. In a case in which the multi RAT mobile station informs the new AP of the conventional AP address during the reassociation request, an authentication procedure may be omitted (S326 and S328). An AID is assigned to the multi RAT mobile station through the reassociation response.

The multi RAT mobile station informs the base station of successful association with the new AP and a result thereof (S332). At this time, the multi RAT mobile station transmits a mapping result between a flow ID (FID) and an association ID (AID)/a traffic stream ID (TSID) of a corresponding flow and an IP address assigned by the new AP to the base station. In addition, in a case in which the multi RAT mobile station is reassociated with the AP without an indication of the base station, the multi RAT mobile station must inform the base station thereof. To this end, the multi RAT mobile station may transmit an SS_IND message to the base station in an unsolicited manner.

The multi RAT mobile station may transmit and receive data for a specific flow from the action time through the new AP (S334).

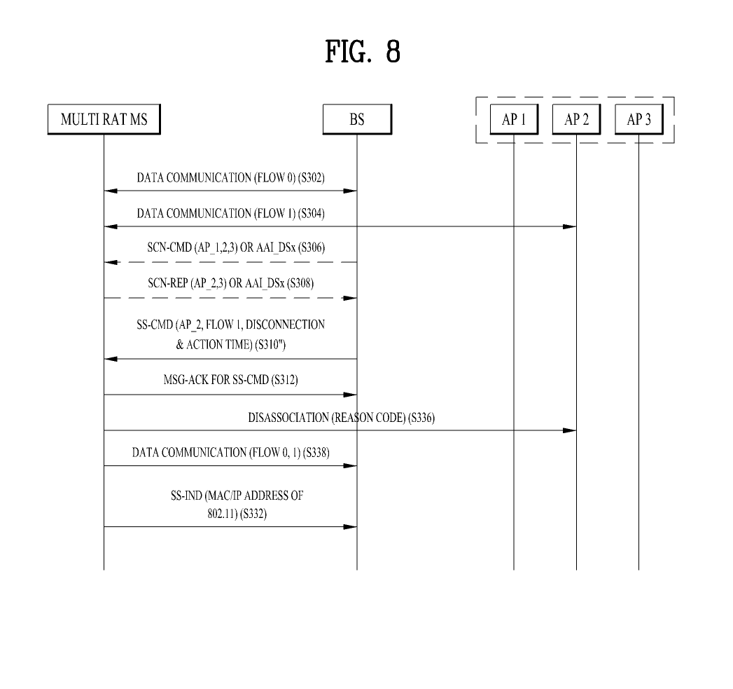

FIG. 8 is a flowchart showing a procedure in which the multi RAT mobile station is disassociated from the secondary system.

The multi RAT mobile station performs data communication for flow 0 with the base station (S302). Subsequently, the multi RAT mobile station performs data communication for flow 1 with the base station through AAI_DSA (S304). In addition, the multi RAT mobile station receives a scan command message from the base station (S306), scans peripheral APs, and transmits a scan report message to the base station (S308). At this time, the base station decides to disassociate the multi RAT mobile station from the AP associated with the multi RAT mobile station based on the scan report message.

The multi RAT mobile station receives an SS-CMD message for disassociation from the AP from the base station (S310″). The SS-CMD message includes the AP from which the multi RAT mobile station will be disassociated and disconnection (and action) time. The multi RAT mobile station may be disassociated from the conventional AP at the disconnection time and may start communication with the base station at the action time. In addition, this value must be a value after the reassociation deadline. The multi RAT mobile station transmits a check message indicating successful reception of the SS-CMD message to the base station (S312).

The multi RAT mobile station transmits a disassociation notification frame to the current AP at the disconnection time (S336). The multi RAT mobile station informs the base station of successful disassociation from the AP (S340). In a case in which the multi RAT mobile station is disassociated from the AP without an indication of the base station, the multi RAT mobile station must inform the base station thereof To this end, the multi RAT mobile station may transmit an SS_IND message to the base station in an unsolicited manner.

The multi RAT mobile station may transmit and receive data for a specific flow from the action time through the base station (S340).

### Description of Embodiments of the Disclosure

Hereinafter, a description will be given in detail of a method of efficiently performing paging of a primary system in a case in which a multi RAT mobile station proposed by the disclosure performs data traffic communication through a secondary system although the multi RAT mobile station is in an idle mode with respect to the primary system.

FIG. 9 is conceptual view showing a multi radio access technology (Multi RAT) network to which an embodiment of the disclosure may be applied.

In general, most mobile stations are in an idle mode when the mobile stations are not used for telephone conversation. In a case in which the multi RAT mobile station controlled by a base station of the primary system generates association with data traffic through the primary system, it may be determined whether the mobile station continues to communicate data for a corresponding flow through the primary system based on location or preference of the mobile station or whether the mobile station performs communication through the second system in a case in which the mobile station is located in an area of the secondary system.

This is determined according to control of the base station. If communication is performed through the secondary system, there is no more data traffic through the primary system. In this case, most multi RAT mobile stations may enter an idle mode of the primary system. The mobile station in the idle mode wakes at a specific time to monitor a paging message transmitted thereto and to check whether the mobile station will enter an active mode.

On the other hand, the multi RAT mobile station which is controlled by the base station of the primary system or a server may know that the corresponding mobile station performs communication through the secondary system and the base station of the primary system or the server knowing that the corresponding mobile station performs communication through the secondary system may transmit a paging message, which may be transmitted through the primary system, through the secondary system in order to minimize battery consumption of the mobile station.

### Definition of Paging Message Transmission Network Indication

In a case in which the base station of the primary system or the server decides switching from specific flow traffic to the secondary system, the base station of the primary system or the server informs the mobile station of transmission of the corresponding traffic to the secondary system through a message such as SS-CMD (or application message). According to a first embodiment of the disclosure, the message may include an indication indicating whether the mobile station monitors a primary system paging message.

### Paging Message Transmission Indication through AAI-SS-CMD

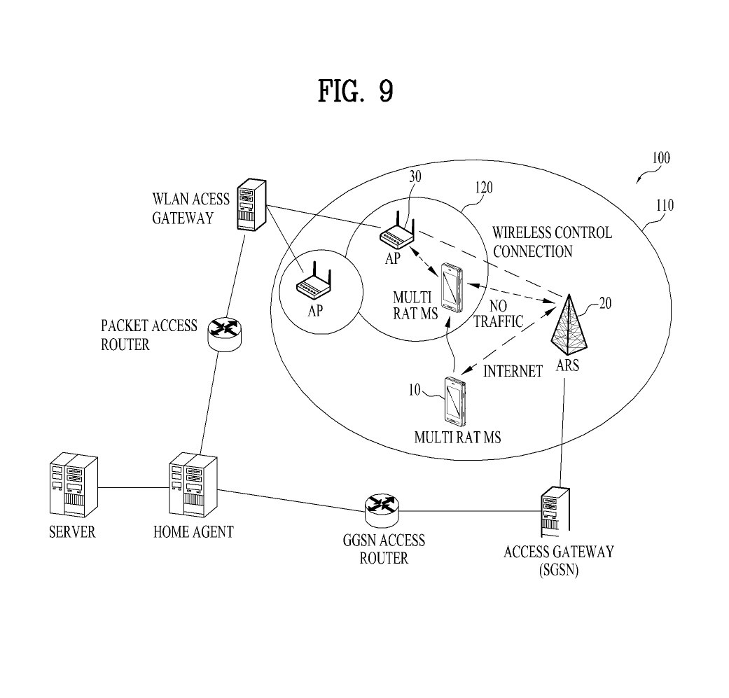

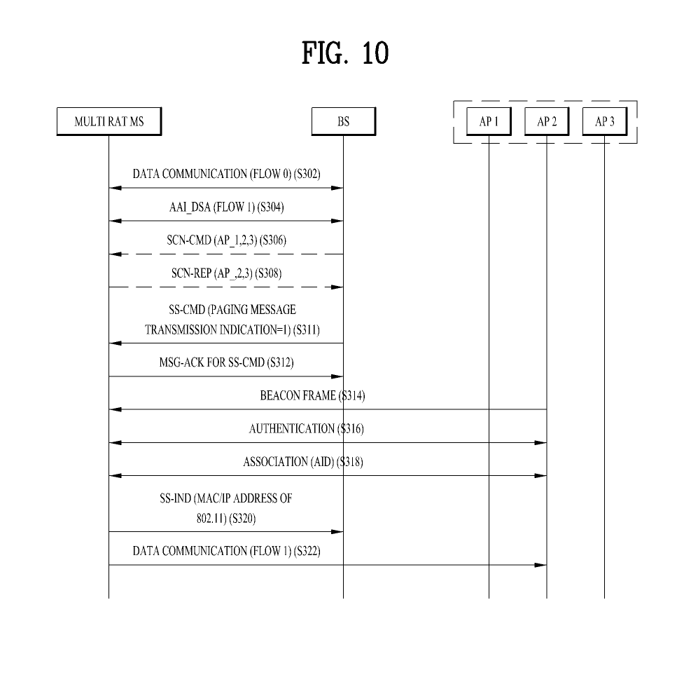

FIG. 10 is a view showing a procedure in which a multi RAT mobile station according to an embodiment of the disclosure is associated with a secondary system.

Operations S302 to S308 shown in FIG. 10 are the same as operations S302 to S308 shown in FIG. 6 and thus a detailed description thereof will be omitted.

At operation S311, control for association with an AP is performed through the base station. For example, a base station informs the multi RAT mobile station of information about a selected AP through a second system selection command (SS-CMD) message (S311). In this case, although not shown, the multi RAT mobile station may request the base station for association with the AP (for example, SS_REQ). At this time, the selected AP, information about a flow transmitted to the secondary system, and an authentication method (open system or shared key) are transmitted from the base station to the multi RAT mobile station. In addition, the SS-CMD message may include whether transition to a doze mode will be performed after association. For power saving, the base station may indicate the multi RAT mobile station to perform transition to the dose mode. In addition, the SS-CMD message may further include synchronization, authentication, and association deadline between the multi RAT mobile station and the AP and action time meaning that transmission and reception of data to and from the secondary system is possible after receiving an SS_IND message, which is a value after the association deadline.

According to an embodiment of the disclosure, the SS-CMD message may further include an indication indicating whether the mobile station monitors a primary system paging message, e.g. a paging message transmission indication. When the paging message transmission indication is 1, the mobile station completing establishment with the secondary system does not monitor a paging message through the primary system after entry into an idle mode of the primary system. Instead, the multi RAT mobile station may receive the paging message through the secondary system. When the paging message transmission indication is 0, on the other hand, the mobile station monitors the paging message through the primary system after entry into the idle mode of the primary system although the mobile station completes establishment with the secondary system. The paging message transmission indication values may have opposite meanings.

If the paging message transmission indication is 1, the mobile station does not need to monitor the paging message transmitted to the primary system in a case in which the mobile station receives a DREG-REQ/RSP message for entry into the idle mode of the primary system during association with the secondary system.

Subsequently, Operations S312 to S318 shown in FIG. 10 are the same as operations S312 to S318 shown in FIG. 6 and thus a detailed description thereof will be omitted.

In a case in which the synchronization, authentication, and association between the multi RAT mobile station and the AP are successful, the multi RAT mobile station transmits an AAI-SS-IND message including a value meaning association between the multi RAT mobile station and the AP to the base station (S320). At this time, the multi RAT mobile station transmits a mapping result between a flow ID (FID) and an association ID (AID)/a traffic stream ID (TSID) of a corresponding flow, a status meaning success/failure, and an IP address assigned by the AP to the base station.

Now, the multi RAT mobile station may transmit and receive data for a specific flow through the secondary system (S322).

In a case in which the base station of the primary system transmits the paging message transmission indication to the multi RAT mobile station through the SS-CMD message, the disclosure has an advantage in that the corresponding message may be transmitted only to the multi RAT mobile station. In other words, the corresponding message is not transmitted to any mobile station other than the multi RAT mobile station, thereby achieving efficient use of resources.

### Paging Message Transmission Indication through AAI-DREG-RSP

Alternatively, the base station of the primary system may transmit a paging message transmission indication indicating whether the mobile station monitors a paging message through an AAI-DREG-RSP message transmitted when the mobile station enters the idle mode to the mobile station. In this case, a corresponding bit may be transmitted to any mobile station other than the multi RAT mobile station as well as the multi RAT mobile station.

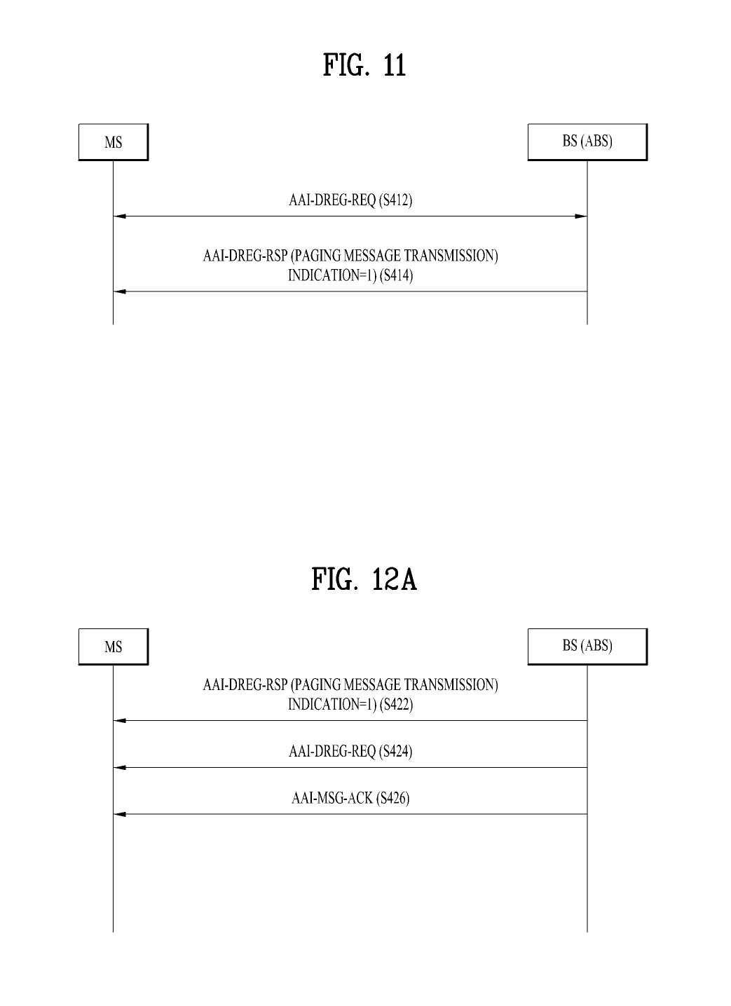

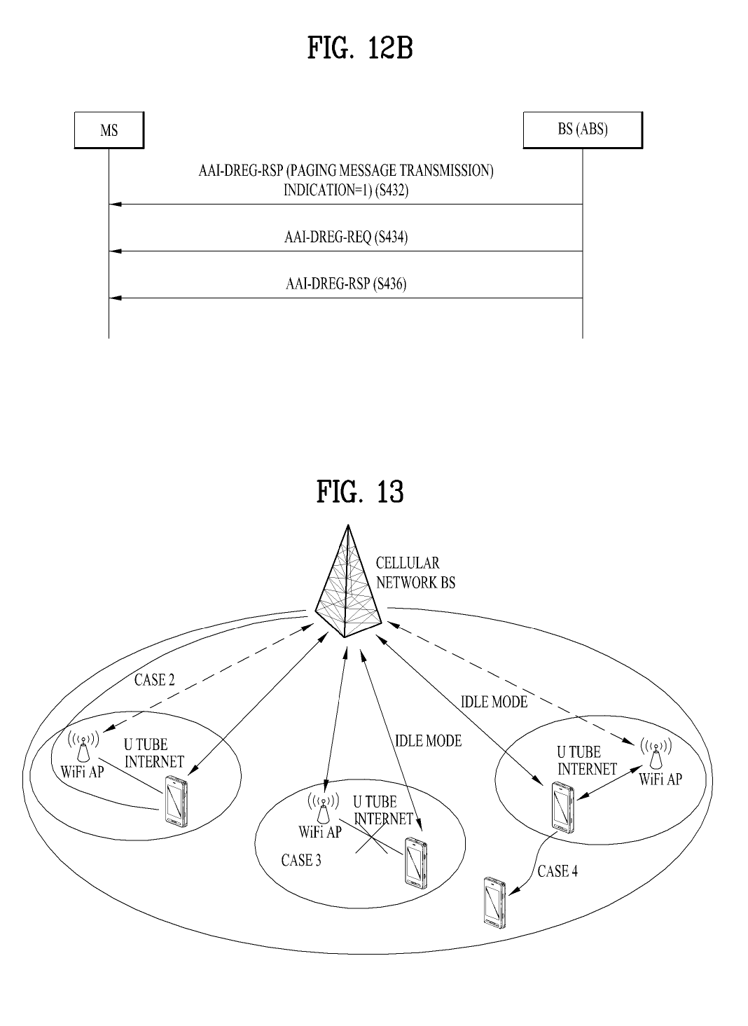

FIGS. 11, 12A, and 12B are views showing a procedure in which a mobile station according to an embodiment of the disclosure enters an idle mode.

FIG. 11 is a view showing a mobile station idle mode entry procedure commenced by a mobile station according to an embodiment of the disclosure.

When the mobile station enters the idle mode, the mobile station transmits an AAI-DREG-REQ message including a parameter indicating request to release registration of the mobile station with the base station and to commence the idle mode in order to transmit a signal to commence the idle mode (S412).

When the base station decides to allow request of the idle mode commenced by the mobile station, the base station transmits an AAI-DREG-RSP message to the mobile station in response to the AAI-DREG-REQ message (S414). At this time, the base station transmits the AAI-DREG-RSP message to the mobile station in a state in which a paging message transmission indication indicating whether the mobile station monitors a paging message is included in the AAI-DREG-RSP message.

FIGS. 12A and 12B are views showing a mobile station idle mode entry procedure commenced by a base station according to an embodiment of the disclosure.

Referring to FIG. 12A, in case of an idle mode entry commenced by the base station, the base station transmits an AAI-DREG-RSP message to the mobile station in an unsolicited manner in order to transmit a signal to commence the idle mode to the mobile station (S422). At this time, the base station transmits the AAI-DREG-RSP message to the mobile station in a state in which a paging message transmission indication indicating whether the mobile station monitors a paging message is included in the AAI-DREG-RSP message.

The mobile station transmits an AAI-DREG-REQ message to the base station in response to the AAI-DREG-RSP message (S424) and the base station transmits an AAI-MSG-ACK message to the mobile station in response to the AAI-DREG-RSP message (S426).

Referring to FIG. 12B, in case of another idle mode entry commenced by the base station, the base station transmits an AAI-DREG-RSP message including REQ-Duration to the mobile station in an unsolicited manner in order to transmit a signal to commence the idle mode to the mobile station (S432). At this time, the base station transmits the AAI-DREG-RSP message to the mobile station in a state in which a paging message transmission indicator indicating whether the mobile station monitors a paging message is included in the AAI-DREG-RSP message.

Upon completion of REQ-Duration, the mobile station transmits an AAI-DREG-REQ message to the base station (S434) and the base station transmits another AAI-DREG-RSP message to the mobile station (S436).

### Other Situations

FIG. 13 is conceptual view showing a multi radio access technology (Multi RAT) network to which another embodiment of the disclosure may be applied.

On the one hand, in a case in which the multi RAT mobile station receives paging through the secondary system (case 2), the multi RAT mobile station may perform network reentry through the primary system and perform communication through the secondary system and the primary system. For example, the multi RAT mobile station may communicate the conventional data traffic through the secondary system and may communicate voice traffic through the primary system.

On the other hand, in a case in which data communication to the primary system is completed while the multi RAT mobile station monitors only the secondary system (case 3), the multi RAT mobile station may perform an idle mode procedure for the primary system while referring to parameter values, such as a paging cycle and a paging offset, defined in the DREG-RSP message received through the primary system.

On yet the other hand, in a case in which the multi RAT mobile station monitoring only the secondary system deviates from an area of the secondary system, the multi RAT mobile station may perform network reentry into the primary system for transmission of the data traffic transmitted and received through the secondary system and may switch the data traffic to the primary system.

### Page Message Transmission Method Through Secondary System

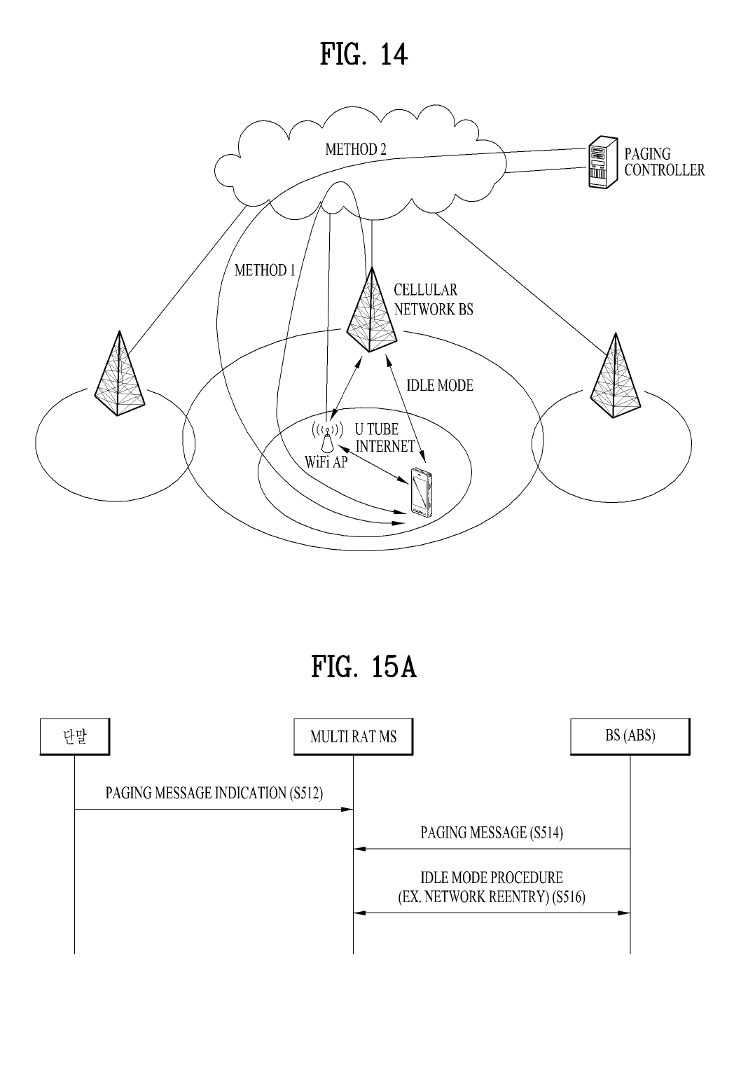

FIG. 14 is a conceptual view showing a procedure in which a multi RAT mobile station according to an embodiment of the disclosure receives a paging message through the secondary system.

When a paging controller indicates the base station to perform paging of the multi RAT mobile station, the base station may transmit a message indicating the corresponding multi RAT mobile station to perform network reentry into the primary system through the secondary system (method 1). This message may be the same as the conventional message that the base station has transmitted to the multi RAT mobile station or an indication message indicating only paging.

Alternatively, the paging controller may transmit a paging message to the multi RAT mobile station through an IP address of the secondary system (method 2). This message may be the same as the conventional message that the paging controller has transmitted to the base station or an indication message indicating only paging.

In a case in which the base station transmits the same message as the message that the paging controller has transmitted to the base station to the multi RAT mobile station, the base station may transmit the paging message to the corresponding multi RAT mobile station using a layer 2 tunneling method.

This is performed on the assumption that the base station of the primary system or the server knows the IP address of the secondary system. In addition, association of the multi RAT mobile station with the secondary system may be set under control of the base station of the primary system or the server. During this process, the IP address of the secondary system may be transmitted to the base station of the primary system or the server.

Meanwhile, in a case in which the paging message transmitted through the secondary system is an upper layer (layer 3 or application message), it is necessary to provide a method of recognizing that the corresponding message is a paging message in a MAC layer of the multi RAT mobile station. In this case, according to an embodiment of the disclosure, the multi RAT mobile station may recognize that the message transmitted to the IP address of the base station or the paging controller is a paging message (or a layer 2 message).

To this end, the multi RAT mobile station may know the IP address of the base station or the paging controller in advance before communication with the secondary system. If the multi RAT mobile station receives a message corresponding to the IP address of the base station or the paging controller, the multi RAT mobile station may recognize the received message as a paging message.

### Idle Mode of Primary System According to an Embodiment of the Disclosure

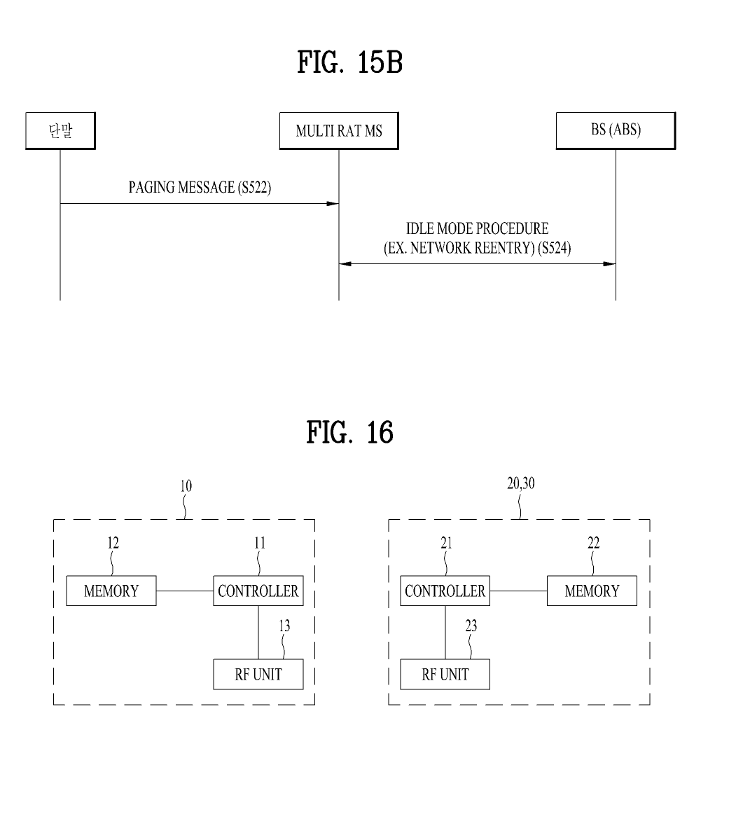

FIGS. 15A and 15B are conceptual views showing a procedure in which a multi RAT mobile station according to an embodiment of the disclosure transmits a paging message through the secondary system.

In a case in which the base station indicates to enter an idle mode (for example, DRX mode of LTE) procedure through a message, such as DREG-RSP (in case of WiMAX), but it is set that it is not necessary to monitor a paging message through the primary system according to a bit, such as paging message transmission indication, the multi RAT mobile station in the idle mode of the primary system must perform a procedure performed by a conventional mobile station except that the paging message is not monitored.

The secondary system idle mode mobile station performs the procedure in the same manner as in the conventional idle mode but recognizes that the corresponding mobile station is performing communication through the secondary system (secondary system idle mode from a viewpoint of the base station). If a paging message is transmitted to the corresponding mobile station, the base station must transmit, through the secondary system, a message indicating to receive the paging message transmitted through the primary system (in a case in which only a paging message indication for the primary system is informed through the secondary system).

Meanwhile, the mobile station does not monitor the primary system but performs communication through the secondary system although the mobile station is in the idle mode (secondary system idle mode from a viewpoint of the mobile station). If the mobile station receives the paging message for the primary system through the secondary system, the mobile station must perform an appropriate procedure through the primary system.

Referring to FIG. 15A, for example, in a case in which only a paging message indication for the primary system is informed through the secondary system (S512), the mobile station receives a paging message using a paging cycle/offset set when entering the idle mode of the primary system through the primary system (S514) and performs a procedure suitable for action code requested by the corresponding message (S516). That is, the corresponding indication is used to inform that the paging message will be transmitted to the primary system.

Alternatively, in a case in which the paging message of the primary system is received through the secondary system (S522), the mobile station performs a procedure suitable for action code requested by the corresponding message (S524). The mobile station receives the same message as the paging message transmitted by the primary system from the AP through the secondary system. In this case, the corresponding message is transmitted only when the corresponding mobile station is paged.

Here, the mobile station idle mode action code procedure includes a network reentry procedure and a location update procedure.

The base station of the primary system or the server may inform the mobile station of system information update through the secondary system as needed. The mobile station, receiving the system information update, updates system information through the primary system.

However, if it is not necessary for the mobile station to receive location update or a paging message through the primary system or to perform the network reentry procedure, it is not necessary for the mobile station to update the system information. The mobile station may check whether system information update is necessary before communication/transmission and reception of a message through the primary system and may update the system information only when necessary.

### Necessity of Location Update in Idle Mode of Primary System

A general idle mode mobile station must perform location update when a specific condition is satisfied. For example, location update must be performed once (power down update) when the mobile station detects that a selected favorite base station does not support a currently assigned page group(s) (paging group based update), when a cycle for performing a location update process comes before lapse of an idle mode timer (timer based update), or as a part of a sequential power down procedure. In addition, the mobile station may inform mobility (slow, medium, or fast) during the location update procedure. Mobility information of the mobile station may be used when a new page group(s) is assigned to the corresponding mobile station. During location update, a deregistration identifier, a paging cycle, and a paging offset of the mobile station may be updated (MBS update).

The primary system idle mode of the multi RAT mobile station according to the embodiment of the disclosure means that association with the secondary system remains unlike an conventional idle mode mobile station. Consequently, it may not be necessary to perform conventional location update.

### Definition of Idle Mode Not Requiring Location Update

In a case in which the mobile station performing data communication to the secondary system is in the idle mode of the primary system as described above, location of the mobile station may be checked through an area of the secondary system. In a case in which the mobile station moves to the AP in the area of the same base station although performing AP handover (HO), it may not be necessary to perform location update. Consequently, the primary system idle mode mobile station according to the embodiment of the disclosure may perform location update only when the mobile station moves from the AP of the serving base station to an AP located in an area of another base station.

This means that location update performed under indication of the base station is not necessary and that location update through a paging message is not performed. Consequently, the primary system idle mode mobile station according to the embodiment of the disclosure expects indication of only network reentry into the primary system through the secondary system.

Consequently, it is not necessary for the primary system idle mode mobile station according to the embodiment of the disclosure to receive a message having the same format as the conventional paging message. The base station of the primary system or the server may indicate only to perform network reentry into the primary system through the secondary system or to monitor a paging message to the primary system.

Parameters that can be transmitted in a simplified paging message transmitted to the secondary system include a network reentry indication and a paging message indication.

When a corresponding bit of the network reentry indication is 1, the mobile station performs network reentry into the primary system (switching to an active mode mobile station). When a corresponding bit of the paging message indication is 1, the mobile station monitors a paging message through the primary system (the idle mode being maintained).

Since the base station recognizes that the mobile station is performing communication through the secondary system although the mobile station is in the idle mode, the base station must not delete context of the mobile station although there is no periodic location update. The base station may set mobility of the mobile station to slow (or no mobility) when the mobile station enters the idle mode.

### Paging Message Resume Indication to Primary System in Case 3

In a case in which data communication to the secondary system is completed while the mobile station monitors only the secondary system, the mobile station performs an idle mode procedure for the primary system while referring to parameter values, such as a paging cycle and a paging offset, defined in the DREG-RSP message received through the primary system.

If the mobile station operates in the idle mode without location update, the mobile station informs that data traffic communication in the area of the secondary system has been ended through location update to the primary system. The location update of the mobile station to the primary system means that the mobile station resumes monitoring of the paging message to the primary system.

The above-described embodiments and modifications may be combined with each other, and thus, may be used alone or in combination thereof, if necessary. The combination may be easily implemented by one of ordinary skill in the art, and thus, a detailed description thereof will not be given here. Although not described, it is to be appreciated that the combination is not precluded, and is within the scope of the invention.

The embodiments and modifications of the disclosure may be implemented by various means. For example, the embodiments of the disclosure may be implemented by hardware, firmware, software, or a combination thereof.

In a hardware configuration, an embodiment of the disclosure may be achieved by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software configuration, an embodiment of the disclosure may be implemented in the form of a module, a procedure, a function, etc. Software code may be stored in a memory unit and executed by a processor. The memory unit is located at the interior or exterior of the processor and may transmit and receive data to and from the processor via various known means.

For example, the methods according to the present invention may be stored in a storage medium (e.g. an internal memory, a flash memory, a hard disk, etc.) and may be implemented as code or commands in a software program that can be executed by a processor (e.g. a microprocessor), which will be described with reference to FIG. 16.

FIG. 16 is an internal block diagram of a mobile station and base stations in a radio access system to which embodiments of the disclosure may be applied.

An mobile station 10 includes a controller 11, a memory 12, and a radio frequency (RF) unit 13.

The mobile station 10 may be fixed or mobile. The mobile station 10 may be referred to as other terms such as a user equipment (UE), a user terminal (UT), a subscriber station (SS), a wireless device, and an advanced mobile station (AMS). In addition, the mobile station 10 includes a multi RAT mobile station.

In addition, the mobile station includes a display unit, a user interface unit, or the like.

The controller 11 implements proposed functions, procedures, and/or methods. Layers of a wireless interface protocol may be implemented by the controller 11.

The memory 12 is connected to the controller 11 to store protocols or parameters for wireless communication. That is, the memory 12 stores a mobile station driving system, applications, and general files.

The RF unit 13 is connected to the controller 11 to transmit and/or receive an RF signal.

Additionally, the display unit may display a variety of information of the mobile station. A well-known element, such as a liquid crystal display (LCD) or an organic light emitting diode (OLED), may be used as the display unit. The user interface unit may include a combination of well-known user interfaces, such as a keypad and a touchscreen.

Base stations 20 and 30 each include a controller 21, a memory 22, and an RF unit 23.

Here, in general, the base stations 20 and 30 may be fixed stations that communicate with the mobile station 10. The base stations 20 and 30 may be referred to as other terms such as NodeB, a base transceiver system (BTS), and an access point. One or more cells may exist in one base station.

The controller 21 implements proposed functions, procedures, and/or methods. Layers of a wireless interface protocol may be implemented by the controller 21.

The memory 22 is connected to the controller 21 to store protocols or parameters for wireless communication.

The RF unit 23 is connected to the controller 21 to transmit and/or receive an RF signal.

The controllers 11 and 21 may each include an application-specific integrated circuit (ASIC), other chipsets, a logical circuit, and/or a data processor. The memories 12 and 22 may each include a read-only memory (ROM), a random access memory (RAM), a flash memory, a memory card, a storage medium, and/or other storage devices. The RF units 13 and 23 may each include a baseband circuit for processing an RF signal. When the embodiments of the disclosure are implemented in the form of software, the above-described methods may be implemented in the form of a module (a procedure, a function, etc.) for performing the above-described functions. The module may be stored in the memories 12 and 22 and may be executed by the controllers 11 and 21.

The memories 12 and 22 may be located inside or outside the controllers 12 and 22 and may be connected to the controllers 11 and 21 via various well-known means.

The terminology used herein is for the purpose of describing particular embodiments only and is not intended to be limiting of the disclosure. Unless otherwise defined, all technical terms used herein have the same meaning as commonly understood by one of ordinary skill in the art to which this present invention pertains and will not be interpreted in overly wide or narrow sense unless expressly so defined herein. If a term used herein is a wrong term by which one of ordinary skill in the art cannot correctly understand the disclosure, the wrong term should be replaced by a technical term by which one of ordinary skill in the art can correctly understand the disclosure. It will be further understood that terms, such as those defined in commonly used dictionaries, should be interpreted as having a meaning that is consistent with their meaning in the context of the relevant art and will not be interpreted in an overly narrow sense.

As used herein, the singular forms are intended to include the plural forms as well, unless the context clearly indicates otherwise. It will be further understood that the terms “comprises” or “includes” are not intended to included all elements or all steps described herein, but do not preclude exclusion of some elements or steps described herein or addition of one or more other elements or steps.

It will be understood that, although the terms first, second, etc. may be used herein to describe various elements, these elements should not be limited by these terms. These terms are only used to distinguish one element from another element. For example, a first element may be termed a second element and a second element may be termed a first element without departing from the teachings of the disclosure.

It will be understood that when an element is referred to as being “connected to” or “accessed to” another element, it may be directly connected or accessed to the other element or intervening elements may be present. In contrast, when an element is referred to as being “directly connected to” or “directly accessed to” another element or layer, there are no intervening elements present.

The embodiments of the disclosure described above are combinations of elements and features of the disclosure. The elements or features may be considered selective unless otherwise mentioned. Each element or feature may be practiced without being combined with other elements or features. Further, an embodiment of the disclosure may be constructed by combining parts of the elements and/or features. Operation orders described in embodiments of the disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the disclosure or included as a new claim by a subsequent amendment after the application is filed.

1. A method of a mobile station receiving a paging message of a primary base station, the mobile station being capable of transmitting and receiving data to and from the primary base station supporting a primary radio access technology (RAT) and a secondary base station supporting a secondary RAT in a radio access system supporting a multi RAT, the method comprising:
establishing association with the primary base station;
receiving a secondary base station association command message comprising a paging message transmission indication from the primary base station;
establishing association with the secondary base station in response to the secondary base station association command message; and
monitoring the paging message of the primary base station through the primary base station or the secondary base station based on the paging message transmission indication.

2. The method according to claim 1, wherein the monitoring step comprises:
receiving a paging message indication from the secondary base station; and
receiving the paging message from the primary base station.

3. The method according to claim 1, wherein the monitoring step comprises receiving a paging message from the secondary base station.

4. The method according to claim 1, wherein the monitoring step comprises receiving an indication of network reentry into the primary base station from the secondary base station.

5. The method according to claim 4, further comprising performing network reentry into the primary base station in response to the network reentry indication.

6. The method according to claim 1, wherein the monitoring step comprises receiving a paging message or a paging indication message from a paging controller or the primary base station through the secondary base station.

7. The method according to claim 6, wherein the monitoring step further comprises, upon receiving a message corresponding to an IP address of the paging controller or an IP address of the primary base station, recognizing the received message as a paging message.

8. The method according to claim 1, wherein location update for the primary base station is not performed during association with the secondary base station.

9. The method according to claim 1, further comprising:
performing data communication with the secondary base station; and
upon completion of data communication with the secondary base station in an idle mode, informing the primary base station of paging message monitoring from the primary base station.

10. The method according to claim 9, wherein the informing step comprises performing location update for the primary base station.

11. The method according to claim 1, wherein the secondary base station association command message comprises AAI-SS-CMD.

12. The method according to claim 1, comprising: before the monitoring step,
receiving a message related to entry into an idle mode from the primary base station; and
entering the idle mode in response to the message related to entry into the idle mode.

13. The method according to claim 1, wherein further comprising: before the monitoring step,
performing data communication with the secondary base station; and
performing deregistration from the primary base station.

14. The method according to claim 1, wherein the primary RAT comprises a wide band RAT and the secondary RAT comprises a local area RAT.

15. The method according to claim 14, wherein the wide band RAT comprises a RAT supporting 802.16 and the local area RAT comprises a RAT supporting 802.11.

16. A mobile station capable of transmitting and receiving data to and from the primary base station supporting a primary radio access technology (RAT) and a secondary base station supporting a secondary RAT in a radio access system supporting a multi RAT, the mobile station comprising:
a radio frequency unit for transmitting and receiving a radio signal to and from an external device; and
a controller connected to the radio frequency unit, wherein the controller establishes association with the primary base station, controls the radio frequency unit to receive a secondary base station association command message comprising a paging message transmission indication from the primary base station, and monitors a paging message of the primary base station through the primary base station or the secondary base station based on the paging message transmission indication.

17. A method of a mobile station receiving a paging message of a primary base station, the mobile station being capable of transmitting and receiving data to and from the primary base station supporting a primary radio access technology (RAT) and a secondary base station supporting a secondary RAT in a radio access system supporting a multi RAT, the method comprising:
receiving a message related to entry into an idle mode comprising a paging message transmission indication from the primary base station;
entering the idle mode in response to the message related to entry into the idle mode; and
monitoring the paging message of the primary base station through the primary base station or the secondary base station based on an indication indicating whether the paging message will be monitored.

18. The method according to claim 17, wherein the monitoring step comprises:
receiving a paging message indication from the secondary base station; and
receiving the paging message from the primary base station.

19. The method according to claim 17, wherein the monitoring step comprises receiving a paging message from the secondary base station.

20. The method according to claim 17, wherein the message related to entry into the idle mode comprises AAI-DREG-RSP.
